(19) United States
(12) Patent Application Publication
(10) Pub. No.: US 2009/0025357 A1
(43) Pub. Date: Jan. 29, 2009

(54) TREE FRUIT COLLECTION DEVICE V-SHAPED SUPPORT

(76) Inventor: Vida Parsa, Santa Ynez, CA (US)

Correspondence Address: FELIX L. FISCHER, ATTORNEY AT LAW, 1607 MISSION DRIVE, SUITE 204, SOLVANG, CA, 93463, US

(21) Appl. No.: 11/828,803

(22) Filed: Jul. 26, 2007

(51) Int. Cl. A01D 46/00

(52) U.S. Cl. 56/329

(57) ABSTRACT

A tree fruit collection device includes a plurality of individual freestanding supports for arrangement radially extending from a tree trunk. At least one net element is suspended between the supports and secured at a proximal circumference of the net element around the tree trunk. The net element provides a frustoconical surface to catch dropped fruit from the tree. Hook and loop fasteners or similar attachment devices are provided for removably securing the net element to the supports.

### BACKGROUND OF THE INVENTION—FILED OF THE INVENTION

This invention relates generally to the field of collection of fruit from fruit bearing trees and more particularly to a device removably attachable to surround a tree trunk to collect naturally dropped fruit prior to ground contact.

### BACKGROUND OF THE INVENTION—RELATED ART

Apple and other fruit bearing trees are typically harvested by hand picking or automated systems which shake the tree to release the fruit. The second operation typically requires a means for catching the fruit to prevent it from striking the ground which creates bruising or other damage to the fruit. Additionally, hand picking must often be a repetitive process since all fruit on the tree may not ripen simultaneously. Particularly for the small orchard operator or home fruit farmer, large automated systems are too costly for economic use. Additionally, labor intensive hand picking can also be costly as well as difficult to schedule effectively.

U.S. Pat. No. 5,875,625 issued on Mar. 21, 1999 entitled FRUIT CATCHER provides a device for commercial use which provides an automated support system that surrounds a fruit tree with a net for fruit collection. A similar device was disclosed in U.S. Pat. No. 1,132,325 issued on Mar. 16, 1915 entitled FRUIT GATHERER. A variation on these commercial scale systems is disclosed in U.S. Pat. No. 6,282,878 issued on Sep. 1, 2001 entitled PRODUCe CATCHER which provides a longitudinal catching system that places rectangular netting under trees for fruit collection.

The prior art devices perform the desired function of fruit collection, however, the complexity and associated cost of such systems are not conducive for use by small operators or hobby farmers. It is therefore desirable to provide a supported net collection system for fruit trees that is inexpensive to construct and simple to operate.

### SUMMARY OF THE INVENTION

The present invention provides a tree fruit collection device which includes a plurality of individual freestanding supports for arrangement radially extending from a tree trunk. At least one net element is suspended between the supports and secured at a proximal circumference of the net element around the tree trunk. The net element provides a frustoconical surface to catch dropped fruit from the tree. Hook and loop fasteners or similar means are provided for removably securing the net element to the supports.

For an exemplary embodiment the free standing supports each incorporate an inner leg set having a first height and an outer leg set having a second height greater then the first height. A support tube extends between the inner and outer leg sets. The inner leg set comprises an inverted V of two legs engaging the support tube at a first end at a common vertex. The outer leg set comprises an inverted V of two legs engaging the support tube at a second end at a common vertex.

In the exemplary embodiment, the net element includes a closure extending from the proximal circumference to an outer circumference. The net can be a single piece or, alternatively, multiple net gores extending intermediate the supports.

In use, the invention is assembled by providing each support with a support tube and attaching an inverted V leg set having a first height forming a vertex at a first end of the support tube and a second inverted V leg set having a second height less than the first height forming a vertex at a second end of the support tube. The supports are arranged around the tree trunk with the support tubes extending radially and the second shorter leg set adjacent the tree trunk. The net element is suspended between the supports and secured at a proximal circumference around the tree trunk. A closure in the net is secured and the net element provides a frustoconical surface to catch dropped fruit from the tree.

### BRIEF DESCRIPTION OF THE DRAWINGS

These and other features and advantages of the present invention will be better understood by reference to the following detailed description when considered in connection with the accompanying drawings where:

FIG. 1 is a pictorial view of a first embodiment of the invention in place around a fruit tree;

FIG. 2 is an isometric view of an exemplary support included as a portion of the combination for one embodiment of the invention;

FIG. 3 is a partial view showing details of the netting and securing elements with two supports for one sector of the exemplary embodiment of the invention; and,

FIG. 4 is a partial view showing details of the netting closure system for the exemplary embodiment.

### DETAILED DESCRIPTION OF THE INVENTION

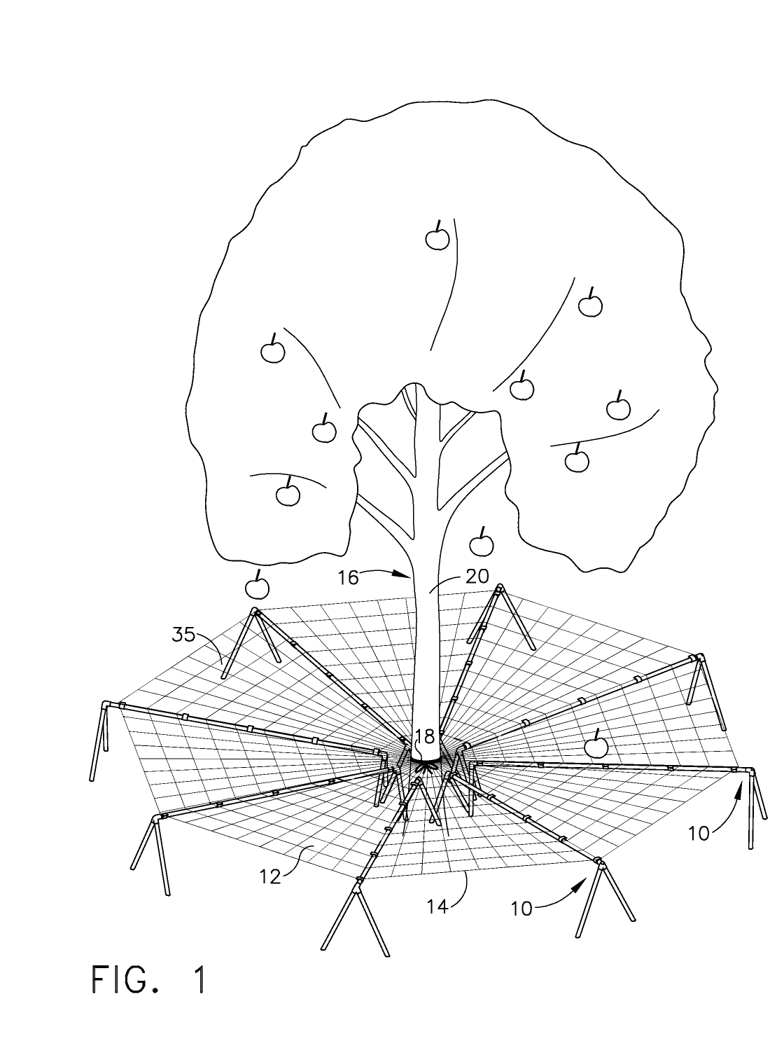

Referring to the drawings. FIG. 1 demonstrates en exemplary embodiment of the invetion for use with fruit trees such as apple or pear trees. The embodiment employs multiple supports 10 from which a frusto-conical net 12 is supported. In an examplary unit, the outer circumference 14 of the net is about 15 feet to provide a sufficient fruit gathering area for a fruit tree 16 pruned at normal orchard size. The inner circumference 18 of the net snuggly surrounds the trunk 20 of the tree. The net is formed in the exemplary embodiment as a single element but in alternative embodiments, individual gores between the supports or extending across multiple supports are employed.

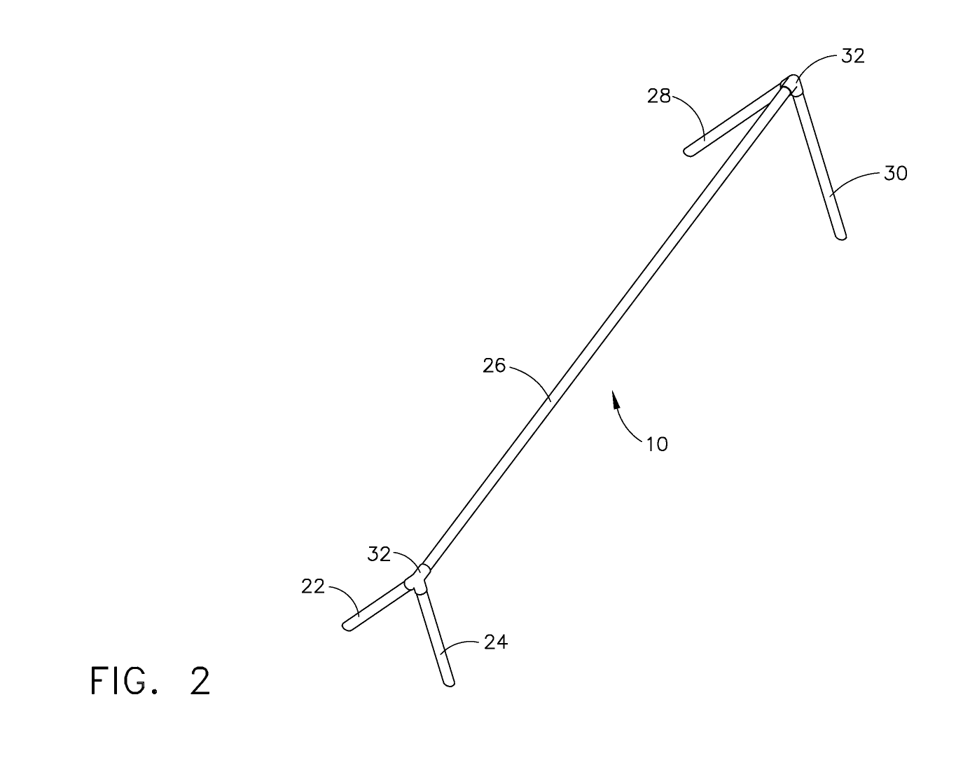

FIG. 2 shows the details of a support 10 exemplary of the multiple supports employed in the embodiment shown to surround the tree in a radial pattern. An inverted V-shaped set of legs 22, 24 supports a radially extending support tube 26 on which the net is supported and constrained. A second set of inverted V-shaped legs 28, 30 supports the tube at the outer circumference. For the exemplary embodiment, the outer leg set is longer than the inner leg set to create the frustoconical shape of the net to urge dropped fruit into the center of the net around the trunk of the tree for easy collection. The exemplary embodiment employs two inverted V leg sets. In alternative embodiments, one inverted V leg set for stability with a single straight leg at the other end of the support tube, or rectangular supports for leg sets created using a horizontal element perpendicular to the support tube with vertical legs depending from the horizontal supports are employed. For the exemplary embodiment, the legs and support tube are formed from 1 inch diameter Polyvinyl Chloride (PVC) pipe such as that used for standard irrigation plumbing with standard three element slip fittings 32 joining the pipe elements at a common vertex. With an approximate 5 foot length of the support tube in the exemplary embodiment, a 12 inch length of the outer legs and a 6 inch length for the inner legs provides adequate slope in the net for collection of the fruit.

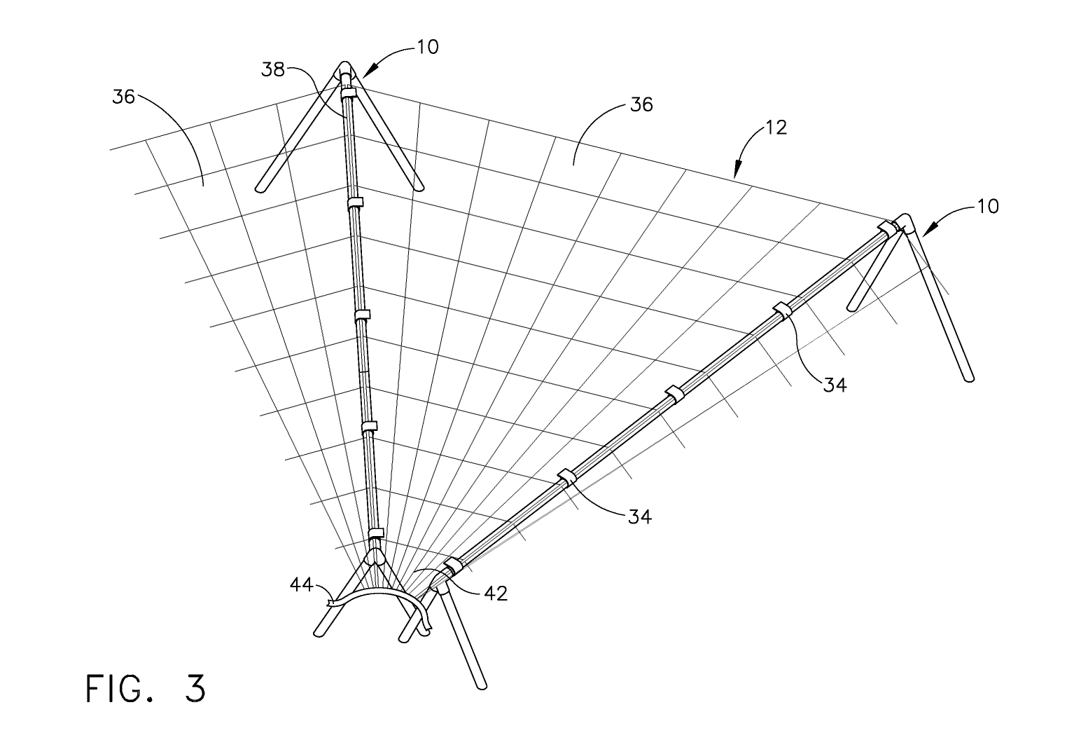

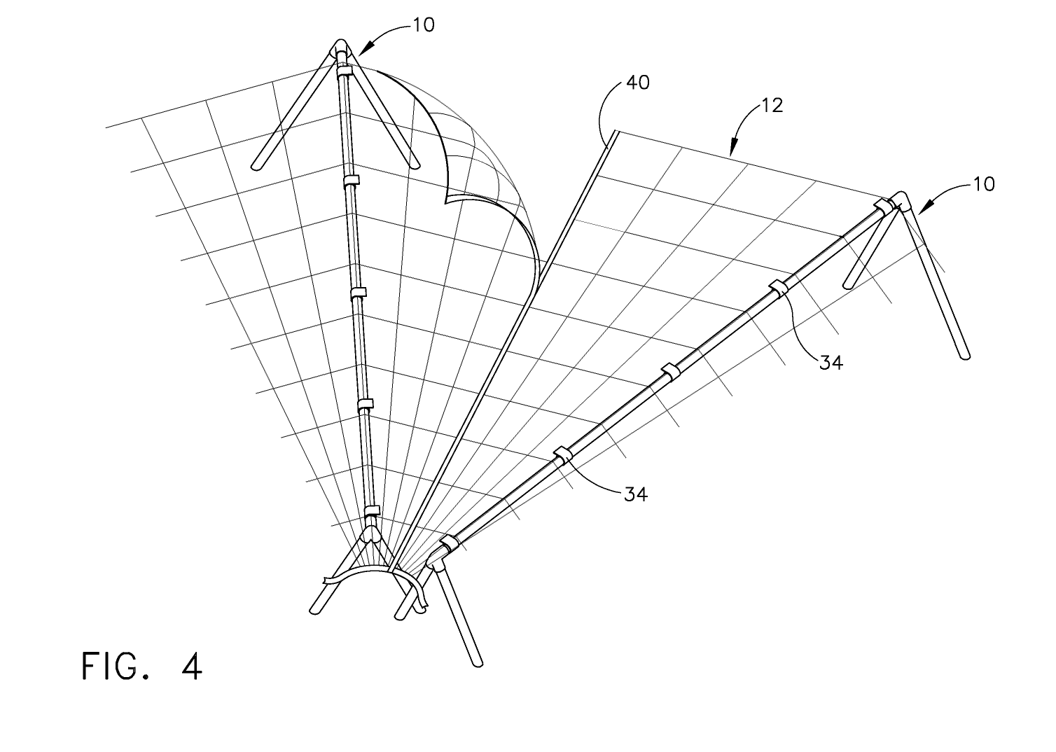

The net employed in the exemplary embodiment is vinyl mesh as shown in FIG. 3. The porosity of the mesh is selected to prevent fruit from falling through but in most embodiments will be fairly open for light weight and easy handling. The mesh is secured to the tube on each support with multiple hook and loop fabric bands 34 such as VelcroR stripping. For embodiments employing multiple individual gores 36, the bands secure the edges 38 of the individual gores along the tube. A single piece net for the exemplary embodiment as shown in FIG. 4 is provided with an opening seam 40 for attaching the net around the tree trunk. A hook and loop strip is employed in the exemploary embodiment for closure of the opening seam. in alternative embodiments, a zipper, eyelet and tie, snaps or hooked fasteners are employed for securing the gores to the supports and to one another. Returning to FIG. 3, the inner portion of the net 42 is flexible for arrangement around the tree trunk. Excess length of the net beyond the support tube length is employed in the exemplary embodiment for added flexibility in assembly. A tie ribbon 44 is attch to or threaded through the net adjacent the inner circumference to secure the net to the tree trunk to prevent dropped fruit from falling between the net and trunk.

The present invention provides simplified setup and removal from the tree. The supports are arranged in a radial pattern surrounding the base of the tree tunk. For the examploary embodiment, 8 to 12 supports are employed to provide an outer base length for each gore of approximately 15 inches. For embodiments with stiffer netting or smaller diameters, fewer supports are required to provide adequate tnesion in the net to catch the dropping fruit without collapsing. Six supports are shown in FIG. 1 for simplicity. The use of multiple individual supports allows asymmetric placement if required to accommodate terrain or other impediments which may surround the tree. After the supports are in place, the net is unrolled over the supports, as individual gores or as a single piece net, and secured to the tubes. When the net surrounds the trunk, the tie ribbon is employed to secure the inner diameter of the net to the trunk. For a single net application the opening seam is then closed or the final gore seam in a multiple gore embodiment is secured to the tubes with the hook and loop fastening syste. For retrieving dropped fruit the opening seam is opened to allow access to the proximity of the trunk and upon completion of the retrieval operation, is resealed for continuing collection of dropping fruit. Upon completion of the hervest, the opening seam is released and the net is rolled from the supports, or individual gores collected, removing the hook and loop fastening tapes at each support tube. The supports can then be collect and stored or disassembled for more compact storage.

Having new described the invention in detail as required by the patent statues, those skilled in the art will recognize modifications and substitutions to the specific embodiments disclosed herein. Such modifications are within the scope and intent of the present invention as defined in the following claims.

1. A tree fruit collection device comprising:
a plurality of individual freestanding supports for arrangement from a tree trunk and each having a radially extending support tube angled upward from proximate the tree trunk to distal the tree trunk;
at least one net element suspended between the supports and having means for securing a proximal circumference of the net element around the tree trunk, said net element resting on the support tubes providing a frustoconical surface to catch dropped fruit from the tree; and
means for removably securing the net element to the supports.

2. A tree fruit collection device as defined in claim 1 wherein the free standing supports each comprise:
an inner leg set having a first height;
an outer leg set having a second height greater than the first height; and
the support tube extending between the inner and outer leg sets.

3. A tree fruit collection device as defined in claim 2 wherein the inner leg set comprises an inverted V of two legs engaging the support tube at a common vertex.

4. A tree fruit collection device as defined in claim 2 wherein the outer leg set comprises an inverted V of two legs engaging the support tube at a common vertex.

5. A tree fruit collection device as defined in claim 1 wherein the net element further includes a closure extending from the proximal circumference to an outer circumference.

6. A tree fruit collection device as defined in claim 1 wherein the at least one net element comprises a plurality of net gores extending intermediate the supports.

7. A tree fruit collection device comprising:
a plurality of individual freestanding supports for arrangement radially extending from a tree trunk, each support having
an inner leg set having a first height and incorporating an inverted V of two legs of circular cross section;
an outer leg set having a second height greater than the first height and incorporating an inverted V of two legs of circular cross section; and
an angled support tube extending between the inner and outer leg sets, each leg set engaging the support tube at a common vertex;
a net element suspended between the supports and having means for securing a proximal circumference of the net element around the tree trunk and including a closure extending from the proximal circumference to an outer circumference, said net element connected to the support tubes to provide a frustoconical surface to catch dropped fruit from the tree; and
means for removably securing the net element to the supports.

8. A method for tree fruit collection comprising the steps of:
providing a plurality circular support tubes;
attaching an inverted V leg set having a first height forming a vertex at a first end of the support tube; and,
attaching a second inverted V leg set having a second height less than the first height and forming a vertex at a second end of the support tube;
arranging the supports by placing the second inverted V leg set of each of the plurality of freestanding supports adjacent the a trunk to radially extend from the tree trunk with the support tube angled upward from the trunk;
providing a net element;
suspending the net element between each support tube establishing a plurality of gores intermediate each set of adjacent supports;
securing a proximal circumference of the net element around the tree trunk; and,
securing a closure in the net, said net element providing a frustoconical surface to catch dropped fruit from the tree.

9. (canceled)

10. (canceled)

11. A fruit tree collection device as defined in claim 7 wherein the legs and support tube are formed from 1 inch diameter Polyvinyl Chloride (PVC) pipe with standard three element slip fittings joining the pipe elements at a common vertex.

12. A fruit tree collection device as defined in claim 11 wherein the support tube is about 5 feet in length, each leg in the outer V leg set is about 12 inches in length and each leg in the inner V leg set is about 6 inches in length.
